(19) United States
(12) Patent Application Publication
(10) Pub. No.: US 2022/0061627 A1
(43) Pub. Date: Mar. 3, 2022

(54) AUTOMATIC DISHWASHING METHOD AND PACK

(71) Applicant: The Procter & Gamble Company, Cincinnati, OH (US)

(72) Inventors: Nina Elizabeth GRAY, Newcastle upon Tyne (GB); Louise Amy IRVINE, Wallsend (GB); Patrick Firmin August DELPLANCKE, Steenhuize-Wijnhuize (BE); Emma J. WATSON, Newcastle upon Tyne (GB); Vania Cristina CROCE MAGO, Newcastle upon Tyne (GB)

(21) Appl. No.: 17/392,321

(22) Filed: Aug. 3, 2021

(30) Foreign Application Priority Data
Aug. 4, 2020 (WO) US2020/070354

(51) Int. Cl. A47L 15/42; A47L 15/46

(52) U.S. Cl. CPC A47L 15/4231; A47L 15/46

(57) ABSTRACT

A method of cleaning dishware in a domestic dishwasher, the method having the steps of: placing the dishware in the dishwasher; delivering a first high-alkalinity composition into the dishwasher to create a first wash liquor having a pH of 11 or greater; delivering a second lower-alkalinity composition into the dishwasher to create a second wash liquor having a pH of less than 11; and subjecting the dishware to the first composition before subjecting it to the second composition.

### FIELD OF THE INVENTION

The present invention is in the field of automatic dishwashing. In particular, it relates to a method to provide effective cleaning, in particular tea cleaning and/or removal of tough food soils such as cooked-on, baked-on and burnt-on soils. The method provides good removal of tea stains even in the absence of bleach and even when used in hard water. There is also provided a pack for use in the method of the invention.

### BACKGROUND OF THE INVENTION

Removal of tea stains and tough food soils such as cooked-on, baked-on and burnt-on soils from dishware seem to be recurring issues in automatic dishwashing.

WO2020/104611 A1 provides a method for removing stains, in particular tea stains in automatic dishwashing without using bleach. The method involves releasing a first cleaning agent at temperature below 40° C. and releasing a main cleaning agent during the main wash cycle when the temperature inside the dishwasher during the main wash cycle exceeds a predetermined temperature threshold.

It is an objective of the present invention to provide an alternative method for tea stain removal.

The automatic dishwashing detergent formulator is continuously looking for ways to improve the performance of detergents. Cooked-, baked-, burnt-on soils are among the most difficult soils to remove. The removal of cooked-, baked- and burnt-on soils from dishware may require soaking the soiled ware prior to a mechanical action. Apparently, the automatic dishwashing process alone does not provide a satisfactory removal of cooked-, baked- and burnt-on soils. In particular, cooked-, baked-, burnt-on soils containing proteins, such as meat, egg and dairy products. The removal of cooked-, baked-, burnt-on soils is more difficult when the detergent is phosphate free. EP 3 339 410 A1 teaches the used of alkyl amphocarboxylate surfactants to improve the removal of cooked-, baked- and burnt-on soils from dishware.

It is an objective of the present invention to provide an alternative method or improve even further the removal of cooked-on, baked-on and burnt-on soils.

### SUMMARY OF THE INVENTION

According to the first aspect of the invention, there is provided a method of cleaning dishware in a domestic dishwasher. The method comprises the following steps:
a) placing the dishware in the dishwasher;
b) delivering a first high-alkalinity composition into the dishwasher to create a first wash liquor having a pH of 11 or greater, preferably 11.5 or greater, more preferably about 12 or greater, preferably the high-alkalinity composition comprises an alkali metal hydroxide;
c) delivering a second lower-alkalinity composition into the dishwasher to create a second wash liquor having a pH of less than 11 and preferably more than 9; and
d) subjecting the dishware to the first composition before subjecting it to the second composition.

According to the second aspect of the invention, there is provided an automatic dishwashing pack. The pack is suitable for use in the method of the invention. The pack comprises at least two different compartments, a first compartment comprising the first high-alkalinity composition capable to provide a pH above 11, preferably a pH of about 12 or greater when added to the wash water and a second compartment comprising the second lower-alkalinity composition capable to provide a pH of less than 11 and preferably about 9 or greater when added to the wash water.

According to the third aspect of the invention, there is provided the use of the method of the invention to provide tea stain removal and/or removal of cooked-on, baked-on, and burnt-on soils.

The elements of the first aspect of the invention apply mutatis mutandis to the second and third aspects of the invention.

### DETAILED DESCRIPTION OF THE INVENTION

The present invention encompasses a method of washing dishware in a dishwasher, a pack to use in the method and the use of the method to provide tea stain removal and/or removal of cooked-on, baked-on, and burnt-on soils. The method takes place in a domestic dishwasher.

Automatic dishwashing machines may be domestic or commercial/institutional machine types. Generally, the differences are in terms of size, volume of throughput and duration of the dishwashing process. This can mean the machines are designed in very different ways. Industrial/institutional machines often have much shorter but more energy intensive (e.g. higher temperature) cycles compared to domestic machines, and/or use much more aggressive chemistry.

Typically, they will not use enzymes, because these need a certain contact time with the treated soils to perform effectively, and the commercial cycle time is too short. In the case of commercial dishwashers, the machines can be based on a conveyor system in which dishware is moved through a single or multiple tanks of the dishwasher, whereas in domestic machines the dishware will generally always remain stationary in one tank inside the dishwasher, and all the washing steps will occur in that single tank. In domestic dishwashing, it is conventional to include bleaches and enzymes in the detergent.

“Dishware” herein means cookware, dishware and tableware, i.e all items related to cooking and serving food and drinks that are usually washed in a dishwasher.

As used herein, the articles including “a” and “an” are understood to mean one or more of what is claimed or described. Unless otherwise noted, all component or composition levels are in reference to the active portion of that component or composition, and are exclusive of impurities, for example, residual solvents or by-products, which may be present in commercially available sources of such components or compositions. Unless specifically stated or the context otherwise requires, embodiments described herein apply equally to all aspects of the invention. Percentages quoted are by weight, unless otherwise stated or the context otherwise requires. All measurements are performed at 25° C. unless otherwise specified.

### Method of the Invention

The method of the invention comprises the following steps to be performed in a domestic dishwasher:
a) placing the dishware in the dishwasher;
b) delivering a first high-alkalinity composition into the dishwasher to subject the dishware to a first wash liquor having a pH of 11 or greater, preferably greater than 11.5, more preferably about 12 or greater and specially about 12; and
c) delivering a second lower-alkalinity composition into the dishwasher to subject the dishware to a second wash liquor having a pH of less than 11 and preferably about 9 or greater.

The first composition is delivered to the dishwasher before the second composition, preferably the first composition is delivered at least 3 minutes, preferably at least 5 minutes before the second composition. The first wash liquor can be discharged before introducing fresh water to form the second wash liquor. Alternatively, the second wash liquor can be formed by adding the second composition to the first wash liquor. In this case, an intermediate step of adding a neutralizer is preferred. Preferably an acid can be added. A preferred acid to use herein is citric acid.

The pH of the first wash liquor can be lowered by the presence of soils coming from the soiled dishware, some of the soils, such as fats are of acidic nature and would lower the pH of the first wash liquor. Better cleaning seems to be obtained when the pH is maintained constant. By “constant” is herein meant that the pH does not change by more than 0.5 pH units, preferably no more than 0.3pH units during at least 50%, more preferably during at least 60% of the time that the dishware is exposed to the first wash liquor.

Preferably, the pH of the first wash liquor is maintained constant by repeated addition of an alkalinity agent, more preferably by adding an alkalinity source, such a sodium hydroxide.

In the context of the present application, “a dishwashing program” is a completed cleaning process that preferably includes a pre-wash, pre-rinse and/or a rinse cycle in addition to the main wash cycle, and which can be selected and actuated by means of the program switch of the dishwasher. The duration of a cleaning programs is advantageously at least 15 minutes, advantageously from 20 to 360 minutes, preferably from 20 to 90 minutes. Within the meaning of this application, “short program” lasts less than 60 minutes and “long program” lasts 60 minutes or more.

A domestic dishwasher can usually provide a plurality of programs, such as a basic wash program, for washing normally dirty dishware dried up to a certain extent; an intensive wash program, for washing very dirty dishware, or in case of food rests particularly difficult to remove (very dry or burnt spots); an economy wash program, for washing lightly dirty dishware or partial loads of dishware; fast wash program, for a washing like the previous cycle, should a faster washing of partial dishware loadings be wished. Each program comprises a plurality of sequential steps. Usually, one or two cold prewash cycles, a cleaning cycle (also known as main wash), a cold rinse cycle, a hot rinse cycle and optionally a drying cycle. During the different cycles of a program, different compositions can be added to the water in the dishwasher to help the cleaning. Preferably, the first composition is delivered into the pre-wash and the second composition into the main-wash cycle.

During the course of a selected dishwashing program a domestic dishwasher generally performs one or more cycles, such as a pre-wash, main-wash, intermediate rinse cycle, final rinse cycle and then a drying cycle to terminate the program. During the respective cycles, wash liquor is distributed, in particular sprayed, by means of a rotating spray arm, a fixed spray nozzle, for example a top spray head, a movable spray nozzle, for example a top spinning unit, and/or some other liquid distribution apparatus, in the treatment chamber of the dishwasher cavity, in which wash liquor is applied to items to be washed, such as dishes and/or cutlery, to be cleaned, which are supported in and/or on at least one loading unit, for example a pull-out rack or a cutlery drawer that can preferably be removed or pulled out. To this end the dishwasher is preferably supplied with wash liquor by way of at least one supply line by an operating circulating pump, said wash liquor collecting at the bottom of the dishwasher cavity, preferably in a depression, in particular in a sump. If the wash liquor must be heated during the respective liquid-conducting washing sub-cycle, the wash liquor is heated by means of a heating facility. This can be part of the circulating pump. At the end of the respective liquid-conducting washing sub-cycle some or all of the wash liquor present in the treatment chamber of the dishwasher cavity in each instance is pumped out by means of a drain pump.

The first composition preferably comprises an alkali metal hydroxide, more preferably sodium hydroxide. The first composition is added to the wash water to form the first wash liquor.

The first wash liquor has a pH above 11, preferably above 11.5 and more preferably about 12 or greater. Additional alkali metal hydroxide is preferably added to the first wash liquor to maintain the pH constant. Preferably the pH is maintained constant for at least 2 minutes, more preferably for at least 3 minutes.

The pH of the compositions of the invention can be measured in 1% weight/volume aqueous solution in distilled water at 20° C.

In a preferred embodiment the second composition comprises enzymes and it is free of bleach, bleach catalyst and bleach activator. It has surprisingly been found that even without the use of bleach the method of the invention provides good removal of tea stains.

In another preferred embodiment the first composition comprises a mixture comprising an alkanol amine, a glycol ether and a complexing agent, preferably the mixture comprises tri-ethanol amine, dipropylene glycol butyl ether and a salt of methyl glycine diacetic acid. This embodiment provides good removal of cooked-, baked- and burnt-soils. Even in short programs.

In another preferred embodiment the second composition comprises a mixture comprising an alkanol amine, a glycol ether and a complexing agent, preferably the mixture comprises tri-ethanol amine, dipropylene glycol butyl ether and a salt of methyl glycine diacetic acid. This embodiment provides good removal of cooked-, baked- and burnt-soils, especially in long programs.

In another preferred embodiment the first composition comprises an alkyl amphocarboxylate surfactant. The carboxylate group in the alkyl amphocarboxylate surfactant comprises from 2 to 4 carbon atoms and the alkyl group in the alkyl amphocarboxylate surfactant comprises from 6 to 24 carbon atoms. Preferably, the alkyl amphocarboxylate surfactant comprises sodium cocoamphoacetate. Preferably, the temperature of the first wash liquor is 30° C. or greater, more preferably greater than 40° C. It has been surprisingly found that better cooked-, baked- and burnt-soil removal is obtained when the alkyl amphocarboxylate is part of the first composition rather than the second composition. The benefits are obtained even in short programs.

### Pack of the Invention

The pack of the invention comprises the first and the second compositions of the method of the invention. The compositions are provided in at least two separate compartments. The pack can have more than two compartments, for example, a first compartment comprising an alkali metal hydroxide and a different compartment comprising a mixture, the mixture comprising an alkanol amine, a glycol ether and a complexing agent and/or an alkyl amphocarboxylate surfactant. The second compartment can comprise enzymes and a different compartment may comprise a builder and/or a dispersant polymer. The pack can be inserted into the dishwasher as such or its content can be used to fill existing storing reservoirs in the dishwasher.

The pack or reservoir containing the compositions of the method of the invention can be located inside or outside of the dishwasher. If placed inside of the dishwasher, the pack or storage reservoir can be integrated into the automatic dishwasher (i.e., a storage reservoir permanently fixed (built in) to the automatic dishwasher), and can also be autarkic (i.e., an independent storage reservoir that can be inserted into the interior of the automatic dishwasher).
An example of an integrated storage reservoir is a receptacle built into the door of the automatic dishwasher and connected to the interior of the dishwasher by a supply line.

The pack can be used as a removable dosing device. The dosing device can be for example an automated unit comprising the pack and a dispensing unit capable of releasing a controlled amount of different compositions at different times, for example to the pre-wash and to the main wash. Different types of hardware might be part of the dosing device for controlling the dispensing of the cleaning composition, or for communicating with external devices such as data processing units, the dishwasher or a mobile device or server that a user can operate.
The pack has very good thermal stability, especially if it is to be located in the interior of the dishwasher.

Preferably, from 1 to 15, more preferably from 2 to 8 grams of the first composition is delivered first, followed by from 1 to 25, more preferably from 2 to 20 grams of the second composition thereafter. In the case in which the first and the second compositions are delivered into the same cycle then it is preferred to add from 1 to 5 grams of a neutralizing agent, preferably and organic acid, more preferably citric acid.

Preferred processes according to the invention are those wherein the compositions, prior to being metered into the interior of the dishwasher, remains in the storage reservoir that is located outside (as for example WO2019/81910A1) or inside of the dishwasher for at least two, preferably at least four, particularly preferably at least eight and in particular at least twelve separate dishwashing programs.

The dosing system can be linked to sensors that can determine, based on sensor's input, the amount of composition required. Sensors that may be used include pH, turbidity, temperature, humidity, conductivity, etc. The dishwasher may require data processing power to achieve this. It is preferred that the dishwashing will have connectivity to other devices. This may take the form of wi-fi, mobile data, blue tooth, etc. This may allow the dishwasher to be monitored and/or controlled remotely. Preferably, this also allows the machine to connect with the internet.

The volume of preferred storage reservoirs containing one or more chambers is from 10 to 1000 ml, preferably from 20 to 800 ml, and especially from 50 to 500 ml.

Alternatively, the first composition can be delivered onto the dishware in the form of a spray before the dishware is placed into the dishwasher. The sprayed composition would give rise to the first wash liquor when it comes in contact with the wash water.

The first composition comprises an alkalinity source preferably an alkali metal hydroxide, more preferably sodium hydroxide.

The first composition may also comprise a mixture comprising an alkanol amine, a glycol ether and a complexing agent. Typical examples of alkanolamines include triethanolamine, monopropanolamine, diethanolamine, dipropanolamine, triethanolamine, tripropanolamine and the like. Preferably, the alkanol amine comprises triethanol amine. Preferably the alkanol amine and the glycol ether are present in the mixture in a weight ratio of from 3:1 to 1:3. Preferably, the alkanol amine comprises triethanol amine. The glycol ether is selected from ethylene glycol monobutyl ether, diethylene glycol monobutyl ether, ethylene glycol monomethyl ether, ethylene glycol monoethyl ether, diethylene glycol monomethyl ether, diethylene glycol monoethyl ether, propylene glycol monobutyl ether, dipropylene glycol monobutyl ether, ethylene glycol phenyl ether and mixtures thereof. The preferred glycol ether for use herein is dipropylene glycol butyl ether. Preferably the alkanol amine and the glycol ether are present in the mixture in a weight ratio of from 3:1 to 1:3.

The preferred complexing agent for use herein is methyl glycine diacetic acid. The mixture preferably comprises triethanol amine, dipropylene glycol butyl ether and methyl glycine diacetic acid. The mixture can alternatively be used in the second composition.

Preferably, the first composition is free of enzymes. By “free of” is herein meant that the composition comprises less than 0.1% by weight of the composition of enzymes.

### Alkyl Amphocarboxylate Surfactant

The first composition may comprise an alkyl amphocarboxylate surfactant. Alkyl amphocarboxylate surfactants include any amphoteric carboxylate surfactant. Amphoteric surfactants characteristically contain both basic and acidic functional groups. Within the surfactants, the basic center is either a secondary or tertiary amine group, depending upon whether the molecule is a mono- or di-carboxylate. The acid properties are provided by the carboxylate group or groups. In acidic solution, the surfactant is a cationic amine salt; in alkaline solution, it is an anionic carboxylate salt.

The carboxylate group in the surfactant of the invention preferably comprises from 2 to 4 carbon atoms, more preferably the carboxylate group is selected from the group consisting of acetate, propionate and mixtures thereof. The alkyl group of the surfactant of the invention preferably comprises from 6 to 24 carbon atoms, more preferably from 8 to 18 carbon atoms, the alkyl group is preferably derived from fatty acids selected from the group consisting of caprylic acid, decanoic acid, lauric acid, myristic acid, palmitic acid and mixtures thereof. Preferably the alkly group is derived from coconut oil.

Preferably the alkyl amphocarboxylate surfactant is selected from the group consisting of alkyl amphoacetate, alkyl amphodiacetate, alkyl amphopropionate, alkyl amphodipropionate and mixtures thereof, more preferably, from the group consisting of sodium cocoamphoacetate, sodium lauroamphoacetate, disodium cocoamphodiacetate, sodium capryloamphoproprionate, di-sodium capryloamphodiproprionate and mixtures thereof. Sodium cocoamphoacetate is the preferred alkyl amphocarboxylate surfactant for use herein.

Commercially available alkyl amphocarboxylate surfactants that may be used in accordance with the present invention include AMPHOSOL® 1C sold by Stepan Company, MACKAM® HPC 32L and MACKAM® 2CY-75 and MIRANOL® Ultra sold by Solvey.

The alkyl amphocarboxylate surfactant is preferably present in an amount ranging from 0.5 to 10%, more preferably from 0.5 to 2% by weight of the first composition.

### Second Composition

The second composition preferably comprises enzymes and optionally but preferably a complexing agent, a polymer, inorganic builder (preferably carbonate and silicate) non-ionic surfactant, etc. In some embodiments the second composition is free of bleach, bleach catalyst and bleach activators.

### Complexing Agent

Complexing agents are materials capable of sequestering hardness ions, particularly calcium and/or magnesium.

The second composition may comprise from 15% to 50%, preferably from 20% to 40%, more preferably from 20% to 35% by weight of the composition of a complexing agent selected from the group consisting of methylglycine-N,N-diacetic acid (MGDA), glutamic acid-N,N-diacetic acid (GLDA), iminodisuccinic acid (IDS), citric acid, aspartic acid -N,N-diacetic acid (ASDA) its salts and mixtures thereof. Especially preferred complexing agent for use herein is a salt of MGDA, in particular the trisodium salt of MGDA. Mixture of citrate and the trisodium salt of MGDA are also preferred for use herein. Preferably, the composition of the invention comprises from 15% to 40% by weight of the composition of the trisodium salt of MGDA.

### Inorganic Builder

The second composition preferably comprises an inorganic builder. Suitable inorganic builders are selected from the group consisting of carbonate, silicate and mixtures thereof. Especially preferred for use herein are sodium carbonate and silicate. Preferably the composition of the invention comprises from 5 to 50%, more preferably from 10 to 40% and especially from 15 to 30% of sodium carbonate by weight of the composition.

### Polymer

The polymer, if present, is used in any suitable amount from about 0.1% to about 30%, preferably from 0.5% to about 20%, more preferably from 1% to 15% by weight of the second composition. Sulfonated/carboxylated polymers are particularly suitable for the second composition.

Suitable sulfonated/carboxylated polymers described herein may have a weight average molecular weight of less than or equal to about 100,000 Da, or less than or equal to about 75,000 Da, or less than or equal to about 50,000 Da, or from about 3,000 Da to about 50,000, preferably from about 5,000 Da to about 45,000 Da.

Preferred sulfonated monomers include one or more of the following: 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

Suitable polymers include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol, preferably from about 5,000 to about 45,000 g/mol. The dispersant polymer may be a low molecular weight homopolymer of polyacrylate, with an average molecular weight of from 1,000 to 20,000, particularly from 2,000 to 10,000, and particularly preferably from 3,000 to 5,000.

The polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000 and more preferably from 20,000 to 50,000 and in particular 30,000 to 40,000 g/mol. and a ratio of (meth)acrylate to maleate or fumarate segments of from 30:1 to 1:2.

The polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such polymer may have a molecular weight of from 4,000 to 20,000 and an acrylamide content of from 0% to 15%, by weight of the polymer.

Polymers suitable herein also include itaconic acid homopolymers and copolymers. Alternatively, the polymer can be selected from the group consisting of alkoxylated polyalkyleneimines, alkoxylated polycarboxylates, polyethylene glycols, styrene co-polymers, cellulose sulfate esters, carboxylated polysaccharides, amphiphilic graft copolymers and mixtures thereof.

### Further Surfactant

Surfactants suitable for use herein, in addition to the alkyl amphocarboxylate surfactant, include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the second composition comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

Further surfactants may be present in a level of from 0.1 to 10%, more preferably from 0.2 to 5% and especially from 0.3 to 3% by weight of the composition.

### Enzymes

The second composition preferably comprises enzyme. More preferably amylases and proteases.

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases for use in the second composition include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include: (a) subtilisins (EC 3.4.21.62), especially those derived from Bacillus, such as Bacillus sp., B. lentus, B. alkalophilus, B. subtilis, B. amyloliquefaciens, B. pumilus , B. gibsonii, and B. akibaii described in WO2004067737, WO2015091989, WO2015091990, WO2015024739, WO2015143360, US 6,312,936, U.S. Pat. Nos. 5,679,630, 4,760,025, DE102006022216A1, DE 102006022224A1 , WO2015089447, WO2015089441, WO2016066756, WO2016066757, WO2016069557, WO2016069563, WO2016069569.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. described in WO2014194032, WO2014194054 and WO2014194117; from Kribella alluminosa described in WO2015193488; and from Streptomyces and Lysobacter described in WO2016075078.

(d) protease having at least 90% identity to the subtilase from Bacillus sp. TY 145, NCIMB 40339, described in W092/17577 (Novozymes A/S), including the variants of this Bacillus sp TY145 subtilase described in WO2015024739, and WO2016066757.

(e) protease having at least 90%, preferably at least 92% identity with the amino acid sequence of SEQ ID NO:85 from WO2016/205755 comprising at least one amino acid substitution (using the SEQ ID NO:85 numbering) selected from the group consisting of 1, 4, 9, 21, 24, 27, 36, 37, 39, 42, 43, 44, 47, 54, 55, 56, 74, 80, 85, 87, 99, 102, 114, 117, 119, 121, 126, 127, 128, 131, 143, 144, 158, 159, 160, 169, 182, 188, 190, 197, 198, 212, 224, 231, 232, 237, 242, 245, 246, 254, 255, 256, and 257, including the variants found in WO2016/205755 and WO2018/118950.

(f) protease having at least 90%, preferably at least 92%, more preferably at least 98% identity with the amino acid sequence of SEQ ID NO:1 from U.S. Pat. No. 10,655,090 B2. A preferred protease has 100% identity with SEQ ID NO:1 from U.S. Pat. No. 10,655,090 B2. Another preferred protease has 1 to 4 modifications with respect to SEQ ID NO:1 from U.S. Pat. No. 10,655,090 B2.

Especially preferred proteases for use in the second composition are: (a) polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN' numbering system and amino acid abbreviations as illustrated in WO00/37627, which is incorporated herein by reference: V68A, N76D, N87S, S99D, S99AD, S99A, S101G, S101M, S103A, V104N/I, G118V, G118R, S128L, P129Q, S130A, Y167A, R170S, A194P, V205I, Q206L/D/E, Y209W and/or M222S. and/or (b) protease having at least 95%, more preferably at least 98%, even more preferably at least 99% and especially 100% identity with the amino acid sequence of SEQ ID NO:85 from WO2016/205755 comprising at least one amino acid substitution (using the SEQ ID NO:85 numbering) selected from the group comprising: P54E/G/I/L/Q/S/T/V; S99A/E/H/I/K/M/N/Q/R/T/V; S126A/D/E/F/G/H/I/L/M/N/Q/R/T/V/Y; D127A/E/F/G/H/I/L/M/N/P/Q/S/T/V/W/Y; F128A/C/D/E/G/H/I/K/L/M/N/P/Q/R/S/T/W, A37T, S39E, A47V, T56Y, I80V, N85S, E87D, T114Q, and N242D;

Most preferably the additional protease is either selected from the group of proteases comprising the below mutations (BPN' numbering system) versus either the PB92 wild-type (SEQ ID NO:2 in WO 08/010925) or the subtilisin 309 wild-type (sequence as per PB92 backbone, except comprising a natural variation of N87S).
(i) G118V+S128L+P129Q+S130A
(ii) S101M+G118V+S128L+P129Q+S130A
(iii) N76D+N87R+G118R+S128L+P129Q+S130A+S188D+N248R
(iv) N76D+N87R+G118R+S128L+P129Q+S130A+S188D+V244R
(v) N76D+N87R+G118R+S128L+P129Q+S130A
(vi) V68A+N87S+S101G+V104N
(vii) S99AD
or selected from the group of proteases comprising one or more, preferably two or more, preferably three or more, preferably four or more of the below mutations versus SEQ ID NO:1 from WO2018/118950:
P54T, S99M, S126A/G, D127E, F128C/D/E/G, A37T, S39E, A47V, T56Y, 180V, N85S, E87D, T114Q, and N242D.

Most preferred for use herein are proteases wherein the protease is a variant having at least 60% identity with the amino acid sequence of SEQ ID NO:1 of WO2019/125894 A1 and comprising at least one amino acid substitution (using the SEQ ID NO: 1 numbering) selected from the group consisting of: X54T; X126A, D, G, V, E, K, I; X127E, S, T, A, P, G, C; and X128E, C, T, D, P, G, L, Y, N and X211L. Preferably, a variant having at least 90% identity with the amino acid sequence of SEQ ID NO:1 and said variant comprising at least one amino acid substitution (using the SEQ ID NO:1 numbering) selected from the group consisting of P54T, S126A, D127E, F128G and M211L
Other preferred protease for use herein include a protease wherein the protease is a variant having at least 90% identity with the amino acid sequence of SEQ ID NO:1 of WO2019/245839 A1 and the variant comprises one or more amino acid substitutions at one or more positions corresponding to SEQ ID NO: 1 positions selected from:
   1C/D/E/M/N, 21L, 37A, 54A, 73V, 76D/H/N/T, 83G, 84D/E/F, 85I/M, 86I/S/T/V, 87T, 88M/V, 89F/W, 91I, 95A/N/S, 96M/Q, 97E, 98M, 99A/F/H/I/K/L/Q/T/W/Y, 102L, 104E, 105L, 106I/V, 108A, 109I, 112C, 114M/N, 115A/E/H/Q, 116A/E/G/H/Q, 118A/D/N, 122C, 124E/Q, 126I/QN, 128H/I/L/M/N/Q/S/T/V/Y, 129D/H, 130N, 131D/E/N/P/Q, 135A/D/H/K/L/M/N/Q/T/V/W/Y, 138D/E, 139E/L, 141A/E/F/H/Y, 142A/D/E, 143E/H/K/M/SN, 156E, and 157C/D/E
   wherein the amino acid positions of the variant are numbered by correspondence with the amino acid sequence of SEQ ID NO: 1.

Suitable commercially available additional protease enzymes include those sold under the trade names Alcalase®, Savinase®, Primase®, Durazym®, Polarzyme®, Kannase®, Liquanase®, Liquanase Ultra®, Savinase Ultra®, Savinase Evity®, Ovozyme®, Neutrase®, Everlase®, Coronase®, Blaze®, Blaze Ultra®, Blaze Evity® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase®, Extremase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D); and KAP (Bacillus alkalophilus subtilisin with mutations A230V+S256G+S259N) from Kao.

Especially preferred for use herein are commercial proteases selected from the group consisting of Properase®, Blaze®, Blaze Evity®, Savinase Evity®, Extremase®, Ultimase®, Everlase®, Savinase®, Excellase®, Blaze Ultra®, BLAP and BLAP variants. Preferred levels of protease in the product of the invention include from about 0.05 to about 20, more preferably from about 0.5 to about 15 and especially from about 2 to about 12 mg of active protease/g of composition.

### Amylases

The second composition can comprise amylases. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCBI 12289, NCBI 12512, NCBI 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) variants described in WO 96/23873, WO00/60060, WO06/002643 and WO2017/192657, especially the variants with one or more substitutions in the following positions versus SEQ ID NO. 12 of WO06/002643:

26, 30, 33, 82, 37, 106, 118, 128, 133, 149, 150, 160, 178, 182, 186, 193, 202, 214, 231, 246, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D 183* and G184*.

(b) variants exhibiting at least 90% identity with SEQ ID No. 4 in WO06/002643, the wild-type enzyme from Bacillus SP722, especially variants with deletions in the 183 and 184 positions and variants described in WO 00/60060, WO2011/100410 and WO2013/003659 which are incorporated herein by reference.

(c) variants exhibiting at least 95% identity with the wild-type enzyme from Bacillus sp. 707 (SEQ ID NO:7 in U.S. Pat. No. 6,093, 562), especially those comprising one or more of mutations in the following positions M202, M208, 5255, R172, and/or M261. Preferably said amylase comprises one or more of M202L, M202V, M2025, M202T, M202I, M202Q, M202W, S255N and/or R172Q. Particularly preferred are those comprising the M202L or M202T mutations.

(d) variants described in WO 09/149130, preferably those exhibiting at least 90% identity with SEQ ID NO: 1 or SEQ ID NO:2 in WO 09/149130, the wild-type enzyme from Geobacillus Stearophermophilus or a truncated version thereof.

(e) variants exhibiting at least 89% identity with SEQ ID NO:1 in WO2016091688, especially those comprising deletions at positions H183+G184 and additionally one or more mutations at positions 405, 421, 422 and/or 428.

(f) variants exhibiting at least 60% amino acid sequence identity with the “PcuAmyl a-amylase” from Paenibacillus curdlanolyticus YK9 (SEQ ID NO:3 in WO2014099523).

(g) variants exhibiting at least 60% amino acid sequence identity with the“CspAmy2 amylase” from Cytophaga sp. (SEQ ID NO:1 in WO2014164777).

(h) variants exhibiting at least 85% identity with AmyE from Bacillus subtilis (SEQ ID NO:1 in WO2009149271).

(i) variants exhibiting at least 90% identity with the wild-type amylase from Bacillus sp. KSM-K38 with accession number AB051102.

(j) variants exhibiting at least 80% identity with the mature amino acid sequence of AAI10 from Bacillus sp (SEQ ID NO:7 in WO2016180748), preferably comprising a mutation in one or more of the following positions modification in one or more positions 1, 54, 56, 72, 109, 113, 116, 134, 140, 159, 167, 169, 172, 173, 174, 181, 182, 183, 184, 189, 194, 195, 206, 255, 260, 262, 265, 284, 289, 304, 305, 347, 391, 395, 439, 469, 444, 473, 476, or 477

(k) variants exhibiting at least 80% identity with the mature amino acid sequence of the fusion peptide (SEQ ID NO:14 in US 2019/0169546), preferably comprising one or more of the mutations H1*, N54S+V56T, A60V, G109A, R116Q/H+W167F, L173V, A174S, Q172N, G182*, D183*,N195F, V206L/Y, V208L, K391A, K393A, I405L, A421H, A422P, A428T, G476K and/or G478K. Preferred amylases contain both the deletions G182* and G183* and optionally one or more of the following sets of mutations:

1. Hl*+G109A+N195F+V206Y+K391A;

2. H1*+N54S+V56T+G109A+A1745+N195F+V206L+K391A+G476K)

3. H1*+N54S+V56T+A60V+G109A+R116Q+W167F+Q172N+L173V+A1745+N195F+V206L+I405L+A421H+A422P+A428T

4. H1*+N545+V56T+G109A+R116Q+A1745+N195F+V206L+I405L+A421H +A422P+A428T;

5. H1*+N545+V56T+G109A+R116H+A1745+N195F+V208L+K393A+G478K;

(1) variants exhibiting at least 80% identity with the mature amino acid sequence of Alicyclobacillus sp. amylase (SEQ ID NO:8 in WO2016180748).

The amylase can be an engineered enzyme, wherein one or more of the amino acids prone to bleach oxidation have been substituted by an amino acid less prone to oxidation. In particular it is preferred that methionine residues are substituted with any other amino acid. In particular it is preferred that the methionine most prone to oxidation is substituted. Preferably the methionine in a position equivalent to 202 in SEQ ID NO:2 is substituted. Preferably, the methionine at this position is substituted with threonine or leucine, preferably leucine.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL®, ATLANTIC®, INTENSA® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE®, PREFERENZ S® series (including PREFERENZ S1000® and PREFERENZ S2000® and PURASTAR OXAM® (DuPont., Palo Alto, Calif.) and KAM® (Kao, 14-10 Nihonbashi Kayabacho, 1-chome, Chuo-ku Tokyo 103-8210, Japan). In one aspect, suitable amylases include ATLANTIC®, STAINZYME®, POWERASE®, INTENSA® and STAINZYME PLUS®, ACHIEVE ALPHA® and mixtures thereof.

Preferably, the product of the invention comprises at least 0.01 mg, preferably from about 0.05 to about 10, more preferably from about 0.1 to about 6, especially from about 0.2 to about 5 mg of active amylase/g of composition.

Preferably, the protease and/or amylase of the second composition are in the form of granulates, the granulates comprise more than 29% of sodium sulfate by weight of the granulate and/or the sodium sulfate and the active enzyme (protease and/or amylase) are in a weight ratio of between 3:1 and 100:1 or preferably between 4:1 and 30:1 or more preferably between 5:1 and 20:1.

Crystal growth inhibitor

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid). Preferably, the composition of the invention comprises from 0.01 to 5%, more preferably from 0.05 to 3% and especially from 0.5 to 2% of a crystal growth inhibitor by weight of the second composition, preferably HEDP.

### Metal Care Agents

Metal care agents may prevent or reduce the tarnishing, corrosion or oxidation of metals, including aluminium, stainless steel and non-ferrous metals, such as silver and copper. Preferably the second composition comprises from 0.1 to 5%, more preferably from 0.2 to 4% and specially from 0.3 to 3% by weight of the composition of a metal care agent, preferably the metal care agent is benzo triazole (BTA).

### Glass Care Agents

Glass care agents protect the appearance of glass items during the dishwashing process. Preferably the second composition comprises from 0.1 to 5%, more preferably from 0.2 to 4% and especially from 0.3 to 3% by weight of the composition of a glass care agent, preferably the glass care agent is a zinc salt.

### Bleach

In some embodiments the composition may comprises from about 8 to about 30%, more preferably from about 9 to about 25%, even more preferably from about 9 to about 20% of bleach by weight of the composition.

Inorganic and organic bleaches are suitable for use herein. Inorganic bleaches include perhydrate salts such as perborate, percarbonate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially dodecanediperoxoic acid, tetradecanediperoxoic acid, and hexadecanediperoxoic acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-a-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for some embodiments include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the second composition comprises from 0.01 to 5, preferably from 0.2 to 2% by weight of the composition of bleach activator, preferably TAED.

### Bleach Catalyst

In some embodiments the second composition may contain a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include manganese triazacyclononane and related complexes; Co, Cu, Mn and Fe bispyridylamine and related complexes; and pentamine acetate cobalt (III) and related complexes.

The second composition may comprise from 0.001 to 0.5, more preferably from 0.002 to 0.05% of bleach catalyst by weight of the composition. Preferably the bleach catalyst is a manganese bleach catalyst, more preferably Manganese 1,4,7-trimethyl-1,4,7-triazocyclononane.

### EXAMPLES

### Example 1

Two automatic dishwashing compositions were made as detailed herein below.

I. Preparation of Test Compositions

Tests were carried out using the following detergent compositions:

| | Automatic | |
|---|---|---|
| | Dishwashing Composition | |
| | 1 | 2 |
| Ingredient | Level (grams active per dose) | |
| Sodium percarbonate | 2.75 | 0 |
| MnTACN (1,4,7-trimethy1-1,4,7- | 0.0051 | 0 |
| triazacyclononane) | | |
| Sodium carbonate | 3.9 | 5.76 |
| Trilon ® Ultimate 1G (Tri-sodium | 5.1 | 5.1 |
| salt of methyl glycine diacetic acid) | | |
| HEDP (Sodium 1-hydroxyethyidene- | 0.78 | 0.78 |
| 1,1-diphosphonate) | | |
| Acusol ™ 588GF (sulfonated | 0.31 | 0.31 |
| polymer supplied by DowChemical) | | |
| Protease granule | 0.085 | 0.085 |
| Amylase granule | 0.012 | 0.012 |
| Lutensol ® TO7 (non-ionic | 0.89 | 0.89 |
| surfactant supplied by BASF) | | |
| Plurafac ® SLF180 (non-ionic | 0.83 | 0.83 |
| surfactant supplied by BASF) | | |
| Benzotriazole | 0.0077 | 0.0077 |
| TOTAL g active | 14.67 | 13.78 |

II. Test Stains-Tea Cups
The tea cups (Schönwald, 6-8mm thick) were soiled with black assam tea, prepared using the following procedure (taken from Recommendations for the Quality Assessment of the Cleaning Performance of Dishwasher Detergents (Part B, Update 2015) from the IKW working group automatic dishwashing detergents):
1. Prepare 3 mmol Ca and Mg (16.8° d) water and adjust to pH7.5 using HCl or NaOH.
2. Prepare ferric sulphate solution by adding 5g Fe₂(SO₄)₃+1 ml HCl (37%) to one litre of demineralised water.
3. Add 0.2 ml of ferric sulphate to four litres of the 3 mmol water and bring to the boil.
4. Prepare two tea bags, each containing 30 g of Twining's Assam loose leave team.
5. Once the water is boiled, add the tea bags and leave to brew for five minutes.
6. After the five minutes fill the tea cup with 100 ml of the tea which should be around 93° C.
7. Remove 20 mls of tea every five minutes until the tea cup is empty.
8. This process is repeated once more with freshly brewed tea.
9. The soiled tea cups are stored for at least three days at room temperature and humidity before use in performance testing.

III. Additional Ballast Soil 1

To add extra soil stress to the test, a blend of soils is added to the dishwasher, as prepared by the procedure described below:

| Ingredient | % content |
|---|---|
| Vegetable oil | 31.6 |
| Margarine | 6.3 |
| Lard | 6.3 |
| Deep-frying fat | 6.3 |
| Whole egg | 15.8 |
| Cream | 9.4 |
| Whole Milk | 6.3 |
| Potato Starch | 2.2 |
| Gravy | 1.7 |
| Wheat Flour | 0.6 |
| Quark Powder | 0.6 |
| Benzoic Acid >99% | 0.3 |
| Tomato Ketchup | 6.3 |
| Mustard | 6.3 |
| Total | 100 |

### Soil Preparation

1. Combine the vegetable oil and whole egg and mix thoroughly (approximately 30 minutes).

2. Add ketchup and mustard, still stirring vigorously.

3. Melt the fats, allow to cool to approximately 40° C., then add to the mixture and blend well.

4. Stir in the cream and milk.

5. Add the powdered solid constituents and mix everything to a smooth paste.

6. Put 50 g of the soil mix into plastic pots and freeze.

IV. Test Wash Procedure
Automatic Dishwasher: Miele, model GSL2
Wash volume: 5000 ml
Length of the Pre-wash 12 minutes
Main Wash Water temperature: 50° C.
Length of the Main Wash 22 minutes (8 minutes holding)
Water hardness: 19 gpg
Detergent addition: Added into the bottom of the automatic dishwasher when the detergent dispenser opens at the start of the main wash (t=15 minutes from start of cycle).
NaOH solution: 206 ml of 50% (19.4M) active NaOH solution was dissolved in 794 ml deionized water to make a 4M (10.3%) NaOH solution.
NaOH addition: The NaOH solution was delivered into the pre-wash at specified times via a plastic tube and syringe without interrupting the cycle. One end of the tube was inside with the other outside of the dishwasher, with the door closed. The tube used should be 50-70 cm long, and up to 5 mm in diameter.
Positioning of test teacups: Top rack; 1× left, 1× right.
Additional soil stress: 2×50 g pots of additional ballast soil added to bottom rack.

### Example 1

One dose of detergent and a separate addition of the NaOH solution was added to the automatic dishwasher as shown below. The NaOH solution was dosed according to pH meter readings of wash liquor, in order to reach and maintain pH 12 throughout the pre-wash (t=3-12). Average NaOH additions over 4 runs are listed in the table below.

| | Composition | Time (mins) and levels of |
|---|---|---|
| Example | (dosed at t = 15) | NaOH solution (milliliters) |
| Formula A | 14.67 g composition 1 | None |
| Formula B | 13.78 g composition 2 | 3 = 10 ml, 5 = 3 ml, |
| | | 8 = 1 ml, 10 = 1 ml |

A dishwasher was loaded with the above items which were washed using Formulas A and B four times, giving 8 replicates of teacups for each test leg (2 replicates per wash). The teacups were then graded on a visual scale of 1-10 where 1 is no removal and 10 is full removal of the tea soil. Average teacup scores are calculated and shown below.

| | Tea Cleaning Grade |
|---|---|
| Formula A | 7.55 |
| Formula B | 8.81 |

As can be seen using NaOH to increase pH of pre-wash above pH 11, improves tea cleaning in the absence of bleach.

### Examples 2-4

Two automatic dishwashing compositions were made as detailed herein below.

I. Preparation of Test Compositions

Tests were carried out using the following detergent composition:

| | Automatic |
|---|---|
| | Dishwashing Composition |
| | 1 |
| | Level (grams |
| Ingredient | active per dose) |
| Sodium carbonate | 1.6 |
| Trilon ® Ultimate 1G (tri-sodium salt | 5.1 |
| of methyl glycine diacetic acid) | |
| HEDP (Sodium 1-hydroxyethyidene-- | 0.78 |
| 1,1 diphosphonate) | |
| Acusol ™ 588GF (sulfonated polymer | 0.31 |
| supplied by DowChemical) | |
| Protease granule | 0.072 |
| Amylase granule | 0.006 |
| Lutensol ® TO7 (non-ionic | 0.89 |
| surfactant supplied by BASF) | |
| Plurafac ® SLF180 (non-ionic | 0.83 |
| surfactant supplied by BASF) | |
| Benzotriazole | 0.008 |
| Sodium disilicate | 0.63 |
| TOTAL g active | 10.96 |

III. Test Stains

a. BoBo Tiles

The Baked-on, Burnt-on (BoBo) soil used was burnt macaroni and cheese on stainless steel tiles, prepared using the following method:
1. 708 mls of water is boiled in a pan on a hob and 82.5 g of Kraft macaroni and cheese dinner® dry pasta is added to the boiling water.
2. The pasta is allowed to cook for 7 minutes.
3. In a separate container 118 mls of full fat milk and 10 g of margarine are mixed and microwaved for 1.3min at high power to melt the margarine.
4. Once the pasta is cooked the water is drained and the pasta along with the milk and dried cheese are added into a food processor and blended for 2 minutes, ensuring the mixture is uniform.
5. The stainless tiles are then prepared by painting an even layer of mixture over the standard metal template which is 1 mm thick and has 8 holes drilled out at 7 mm diameter.
6. The template is removed leaving 80 Macaroni cheese spots 7 mm in diameter.
7. The soiled tiles are then put into an oven at 204° C. for 7 minutes.

III. Additional Ballast Soil 1

To add extra soil stress to the test, a blend of soils is added to the dishwasher, as prepared by the procedure described below

| Ingredient | % content |
|---|---|
| Vegetable oil | 31.6 |
| Margarine | 6.3 |
| Lard | 6.3 |
| Deep-frying fat | 6.3 |
| Whole egg | 15.8 |
| Cream | 9.4 |
| Whole Milk | 6.3 |
| Potato Starch | 2.2 |
| Gravy | 1.7 |
| Wheat Flour | 0.6 |
| Quark Powder | 0.6 |
| Benzoic Acid >99% | 0.3 |
| Tomato Ketchup | 6.3 |
| Mustard | 6.3 |
| Total | 100 |

### Soil Preparation

7. Combine the vegetable oil and whole egg and mix thoroughly (approximately 30 minutes).
8. Add ketchup and mustard, still stirring vigorously.
9. Melt the fats, allow to cool to approximately 40° C., then add to the mixture and blend well.
10. Stir in the cream and milk.
11. Add the powdered solid constituents and mix everything to a smooth paste.
12. Put 50 g of the soil mix into plastic pots and freeze.

IV. Test Wash Procedure
Automatic Dishwashers: Miele, model GSL2
   Beko, model DFN53012W
Wash volume: 5000 ml
Length of the Pre-wash 10 minutes
Main Wash Water temperature: 50° C. (Miele), 35° C. (Beko)
Length of the Main Wash 14 minutes (Miele), 8 minutes (Beko)
Water hardness: 8 gpg
Detergent addition: Added into the bottom of the automatic dishwasher when the detergent dispenser opens at the start of the main wash
Positioning of test BOBO tiles: Top rack
Additional soil stress: 2×50 g pots of additional ballast soil added to bottom rack.

### Example 2

Each BoBo tile is placed on a benchtop rig containing 4 compartments, each mimicking the spraying action of a full scale ADW machine. The tiles are washed in the benchtop rig for 10 minutes in 5 L of water at 8 gpg, 50° C. and adjusted to pH 12 using 9.5 mls of a 50% NaOH solution. Test legs A-C are then placed in the Beko automatic dishwashing machine. The experiment is then repeated.

| | Composition in benchtop | Composition in ADW |
|---|---|---|
| | rig (g active pre-wash) | (g active Main wash) |
| Test leg A | | 10.96 g Composition 1 |
| Test leg B | 5 g Miranol Ultra ® L-32E | 10.96 g Composition 1 |
| Test leg C | | 10.96 g Composition 1 |
| | | 5 g Miranol Ultra ® L32-E |
| | | 1 g Silfoam ® SP 150 |

The tiles are weighed before soil addition, after soil addition, and after washing to calculate % soil removed.

| | BoBo cleaning |
|---|---|
| | (% soil removed) |
| Test leg A | 47 |
| Test leg B | 84 |
| Test leg C | 62 |

As can be seen, the addition of Miranol Ultra® L-32 E in the benchtop rig followed by washing at 35° C. in a Beko automatic dishwashing machine gives improved cleaning of Bobo removal.

### Example 3

Each BoBo tile is placed on a benchtop rig containing 4 compartments, each mimicking the spraying action of a full scale ADW machine. The tiles are washed in the benchtop rig for 10 minutes in 5 L of water at 8 gpg, 30° C. and adjusted to pH 12 using 9.5 mls of a 50% NaOH solution. Test legs A-C are then placed in the Miele automatic dishwashing machine and test legs D and E are then placed in the Beko automatic dishwashing machine. The experiment is then repeated.

| | | Composition in |
|---|---|---|
| | Composition in benchtop | Automatic Dishwasher |
| | rig (g active pre-wash) | (g active Main wash) |
| Test leg A | | 10.96 g Composition 1 |
| Test leg B | 2.5 g triethanolamine | 10.96 g Composition 1 |
| | 2.5 g DOWANOL ™ DPnB | |
| | 5.1 g Trilon ® Ultimate 1G | |
| Test leg C | | 10.96 g Composition 1 |
| | | 2.5 g Triethanolamine |
| | | 2.5 g DOWANOL ™ DPnB |
| | | 5.1 g Trilon ® Ultimate 1G |
| | | 1 g Silfoam ® SP 150 |
| Test leg D | | 10.96 g Composition 1 |
| Test leg E | 2.5 g triethanolamine | 10.96 g Composition 1 |
| | 2.5 g DOWANOL ™ DPnB | |
| | 2.5 g Trilon ® Ultimate 1G | |
| Test leg F | | 10.96 g Composition 1 |
| | | 2.5 g Triethanolamine |
| | | 2.5 g DOWANOL ™ DPnB |
| | | 5.1 g Trilon ® Ultimate 1G |
| | | 1 g Silfoam ® SP 150 |

The tiles are weighed before soil addition, after soil addition, and after washing to calculate % soil removed.

| | BOBO cleaning |
|---|---|
| | (% soil removed) |
| Test leg A | 89 |
| Test leg B | 94 |
| Test leg C | 98 |
| Test leg D | 70 |
| Test leg E | 88 |
| Test leg F | 82 |

As can be seen, addition of triethanolamine, DOWANOL™ DPnB and Trilon® Ultimate 1G improves Bobo removal.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of cleaning dishware in a domestic dishwasher, the method comprising the steps of:
a) placing the dishware in the dishwasher;
b) delivering a first high-alkalinity composition into the dishwasher to create a first wash liquor having a pH of 11 or greater;
c) delivering a second lower-alkalinity composition into the dishwasher to create a second wash liquor having a pH of less than 11; and
d) subjecting the dishware to the first composition before subjecting it to the second composition.

2. A method according to claim 1, wherein the dishware is subjected to the first composition at least 3 minutes before it is subjected to the second composition.

3. A method according to claim 1, comprising the further step of delivering an alkalinity source after the first wash liquor has been created to maintain constant the initial pH of the first wash liquor.

4. A method according to claim 1, wherein the method comprises using a program having a pre-wash and a main-wash wherein the first composition is delivered into the pre-wash and the second composition is delivered into the main-wash.

5. A method according to claim 1, wherein the maximum temperature of the first wash liquor is ambient temperature and the maximum temperature of the second wash liquor is above ambient temperature.

6. A method according to claim 1, wherein the first composition comprises an alkali metal hydroxide.

7. A method according to claim 1, wherein the second composition comprises an enzyme and wherein the first and second compositions are free of bleach.

8. A method according to claim 1, wherein the first or the second composition comprises a mixture comprising an alkanol amine, a glycol ether and a complexing agent.

9. A method according to claim 1, wherein the first or the second composition comprises a mixture comprising tri-ethanol amine, dipropylene glycol butyl ether and a salt of methyl glycine diacetic acid.

10. A method according to claim 1 wherein the first composition comprises a mixture comprising an alkanol amine, a glycol ether and a complexing agent and the method comprises using a short program or the second composition comprises the mixture and the method comprises using a long program.

11. A method according to claim 1 wherein the first composition further comprises an alkyl amphocarboxylate surfactant wherein the carboxylate group in the alkyl amphocarboxylate surfactant comprises from 2 to 4 carbon atoms and the alkyl group in the alkyl amphocarboxylate surfactant comprises from 6 to 24 carbon atoms.

12. A method according to claim 1 wherein the first composition further comprises sodium cocoamphoacetate.

13. A method according to claim 1 wherein the maximum temperature of the first wash liquor is 30° C. or greater.

14. An automatic dishwashing pack suitable for use in the method according to claim 1, the pack comprising at least two different compartments, a first compartment comprising the first composition or part thereof and a second compartment comprising the second composition or part thereof.

15. A method according to claim 1 wherein a pack comprising at least two different compartments, a first compartment comprising the first composition or part thereof and a second compartment comprising the second composition or part thereof is placed into the interior of the dishwasher to dose the first and the second compositions into a plurality of automatic dishwashing programs.
